(19) United States
(12) Patent Application Publication
(10) Pub. No.: US 2023/0227287 A1
(43) Pub. Date: Jul. 20, 2023

(54) SERVER DEVICE, SYSTEM, CONTROL METHOD OF SERVER DEVICE, CONTROL METHOD OF SYSTEM, AND STORAGE MEDIUM

(71) Applicant: NEC Corporation, Minato-ku, Tokyo (JP)

(72) Inventors: Kanako Takada, Tokyo (JP); Kenichi Oosawa, Tokyo (JP); Aya Yamazaki, Tokyo (JP)

(73) Assignee: NEC Corporation, Minato-ku, Tokyo (JP)

(21) Appl. No.: 18/010,877

(22) PCT Filed: Jun. 23, 2020
(86) PCT No.: PCT/JP2020/024628

§ 371 Date: Dec. 16, 2022

(51) Int. Cl. B66B 3/00; B66B 1/46; G04F 10/00; G06V 40/10; G06V 20/50; G06T 13/00; G06T 11/00

(52) U.S. Cl. CPC B66B 3/002; B66B 1/468; G04F 10/00; G06T 11/00; G06T 13/00; G06V 20/50; G06V 40/10; B66B 2201/101; B66B 2201/463; B66B 2201/4638; B66B 2201/4676

(57) ABSTRACT

Provided is a server device with which it is possible to suitably discern whether a user uses an elevator. The server device comprises a first generation unit, a second generation unit, and an output unit. The first generation unit analyzes image data obtained from at least one or more camera devices and generates elevator information pertaining to the usage state of an elevator The second generation unit generates, on the basis of at least the generated elevator information, during-movement reference information that is referred to when the user moves. The output unit outputs the generated during-movement reference information to signage.

### TECHNICAL FIELD

The present invention relates to a server device, a system, a control method of the server device, and a storage medium.

### BACKGROUND ART

Elevators are essential for movement in high-rise buildings. Regarding controlling elevators in high-rise buildings, various measures have been taken for the purpose of relieving congestion or the like.

For example, PTL 1 describes providing an elevator system that can be refurbished even in an existing high-rise office building and is capable of significantly reducing an average waiting time at lunch time when bidirectional peaks are superimposed.

### CITATION LIST

### Patent Literature

[PTL 1] JP 2020-019626 A

### SUMMARY OF INVENTION

### Technical Problem

Although various efforts have been made for the purpose of relieving congestion as described above, an elevator is congested in a certain time zone such as lunch time as described in PTL 1, which causes a situation in which it is necessary to wait in an elevator hall for a long time.

Usually, an employee or the like working in an office is not able to visually recognize a situation of an elevator hall from his/her seat. In addition, when the elevator is congested, the employee or the like often wants to refrain from using the elevator. It is not efficient for such an employee to go to a crowded elevator hall.

A main object of the present invention to provide a server device, a system, a control method of a server device, and a storage medium that contribute to enabling a user to appropriately determine whether to use an elevator.

### Solution to Problem

According to a first aspect of the present invention, there is provided a server device including: a first generation unit that generates elevator information pertaining to a usage status of an elevator by analyzing image data obtained from one or more camera devices; a second generation unit that generates before-movement reference information to be referred to by a user for movement, based on at least the generated elevator information; and an output unit that outputs the generated before-movement reference information to a signage.

According to a second aspect of the present invention, there is provided a system including: a signage that displays information acquired from the outside; and a server device connected to the signage, in which the server device includes: a first generation unit that generates elevator information pertaining to a usage status of an elevator by analyzing image data obtained from one or more camera devices; a second generation unit that generates before-movement reference information to be referred to by a user for movement, based on at least the generated elevator information; and an output unit that outputs the generated before-movement reference information to the signage.

According to a third aspect of the present invention, there is provided a control method of a server device including: generating elevator information pertaining to a usage status of an elevator by analyzing image data obtained from one or more camera devices; generating before-movement reference information to be referred to by a user for movement, based on at least the generated elevator information; and outputting the generated before-movement reference information to a signage.

According to a fourth aspect of the present invention, there is provided a computer-readable storage medium storing a program for causing a computer mounted on a server device to execute processing including: generating elevator information pertaining to a usage status of an elevator by analyzing image data obtained from one or more camera devices; generating before-movement reference information to be referred to by a user for movement, based on at least the generated elevator information; and outputting the generated before-movement reference information to a signage.

### Advantageous Effects of Invention

According to each aspect of the present invention, a server device, a system, a control method of a server device, and a storage medium that contribute to enabling a user to appropriately determine whether to use an elevator are provided. Note that the effect of the present invention is not limited thereto. The present invention may have other effects instead of or in addition to the above-described effect.

### BRIEF DESCRIPTION OF DRAWINGS

FIG. 1 is a diagram for explaining an outline of an example embodiment.

FIG. 2 is a diagram illustrating an example of a schematic configuration of an information notification system according to a first example embodiment.

FIG. 3 is a diagram illustrating an example of a processing configuration of a server device according to the first example embodiment.

FIG. 4 is a flowchart illustrating an example of an operation of an elevator information generation unit according to the first example embodiment.

FIG. 5 is a diagram for explaining the operation of the elevator information generation unit according to the first example embodiment.

FIG. 6 is a diagram illustrating an example of a processing configuration of a signage according to the first example embodiment.

FIG. 7 is a diagram for explaining an operation of a before-movement reference information output unit according to the first example embodiment.

FIG. 8 is a diagram for explaining an operation of a before-movement reference information output unit according to the first example embodiment.

FIGS. 9 is a diagram for explaining an operation of a before-movement reference information output unit according to the first example embodiment.

FIG. 10 is a diagram illustrating an example of a schematic configuration of an information notification system according to a second example embodiment.

FIG. 11 is a flowchart illustrating an example of an operation of an elevator information generation unit according to the second example embodiment.

FIG. 12 is a diagram for explaining an operation of a before-movement reference information output unit according to the second example embodiment.

FIG. 13 is a diagram illustrating an example of a processing configuration of a server device according to a third example embodiment.

FIG. 14 is a diagram for explaining an operation of a before-movement reference information output unit according to the third example embodiment.

FIG. 15 is a diagram illustrating an example of a processing configuration of a server device according to a fourth example embodiment.

FIG. 16 is a diagram illustrating an example of a schedule information database according to the fourth example embodiment.

FIG. 17 is a diagram illustrating an example of a hardware configuration of the server device.

### EXAMPLE EMBODIMENT

First, an outline of an example embodiment will be described. Note that the reference signs used in the drawings are attached to the respective elements in this outline for convenience as an example for assisting understanding, and the description of this outline is not intended to make a limitation. In addition, unless particularly explained, a block illustrated in each drawing represents a functional unit rather than a hardware unit. A connection line between blocks in each drawing refers to both a bidirectional line and a unidirectional line. A unidirectional arrow schematically indicates a main flow of a signal (data), and does not exclude bidirectionality. Note that, in the present specification and the drawings, elements that can be similarly described are denoted by the same reference sign, so that redundant description can be omitted.

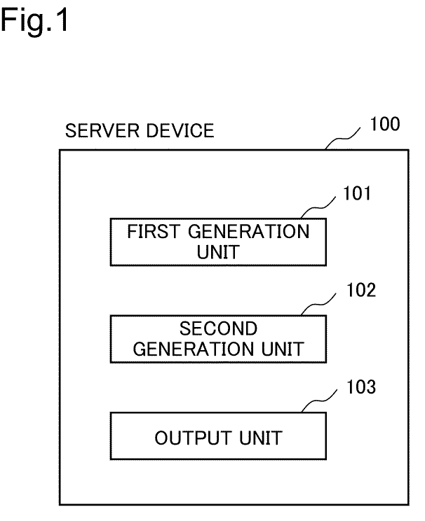

A server device 100 according to an example embodiment includes a first generation unit 101, a second generation unit 102, and an output unit 103 (see FIG. 1). The first generation unit 101 generates elevator information pertaining to a usage status of an elevator by analyzing image data obtained from one or more camera devices. Based on at least the generated elevator information, the second generation unit 102 generates before-movement reference information to be referred to by a user for movement. The output unit 103 outputs the generated before-movement reference information to a signage.

The server device 100 generates information for an employee or the like to discern a usage status of an elevator without having to reaching an elevator hall, and outputs the generated information to the signage. The employee or the like can check a display displayed on the signage, and determine whether to move using the elevator in consideration of a congestion status of the elevator or the like. That is, the employee or the like can appropriately determine whether to use the elevator, taking into account what work is being done, the conditions under which movement is required, etc. all together.

Hereinafter, specific embodiments will be described in more detail with reference to the drawings.

### First Example Embodiment

A first example embodiment will be described in more detail with reference to the drawings.

### System Configuration

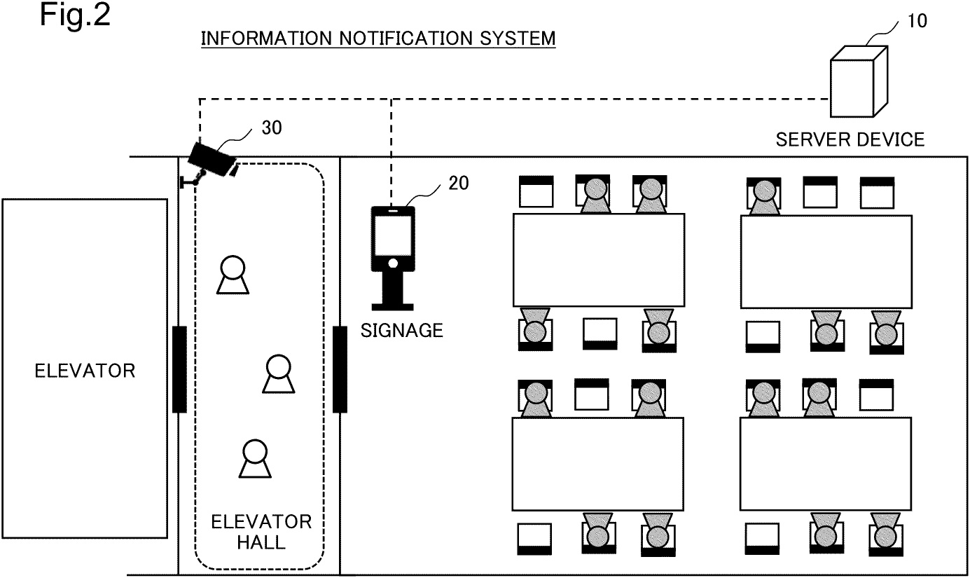

FIG. 2 is a diagram illustrating an example of a schematic configuration of an information notification system according to the first example embodiment. Referring to FIG. 2, the information notification system includes a server device 10, a signage 20, and a camera device 30.

The devices illustrated in FIG. 2 are connected to each other. For example, the server device 10 and the signage 20 are connected to each other by a wired or wireless communication means to be able to communicate with each other.

The server device 10 may be installed on the same floor or in the same building as the signage 20, or may be installed on a network (on a cloud).

The information notification system illustrated in FIG. 2 is a system that notifies an employee or the like working in an office or the like of useful information. The information notification system is a system that provides information useful if referred to, particularly by an employee who moves from an office or the like using an elevator (hereinafter referred to as before-movement reference information).

For example, the employee or the like is notified of information pertaining to a usage status of the elevator (hereinafter referred to as elevator information). For example, the employee or the like is notified of the number of persons waiting for the elevator in the elevator hall, a waiting time required until the elevator arrives, and the like as elevator information. More specifically, the elevator information (the number of waiting persons and the waiting time) is displayed on the signage 20.

The server device 10 acquires various types of information from external devices including the camera device 30. The server device 10 generates before-movement reference information to be output to the signage 20 based on the acquired external information. For example, the server device 10 generates elevator information by analyzing image data obtained from the camera device 30 capable of imaging the entire elevator hall. The server device 10 generates “before-movement reference information” from the elevator information and provides the before-movement reference information to the signage 20.

The signage 20 is a device that displays information acquired from the outside (server device 10). The signage 20 is installed at a conspicuous place on the floor. More specifically, the signage 20 is installed at such a position as to be visually recognized in an easy way by an employee or the like working in an office. The signage 20 displays the “before-movement reference information” acquired from the server device 10 to notify the employee or the like of a usage status of the elevator and the like.

Note that the configuration of the information notification system illustrated in FIG. 2 is an example and is not intended to limit the configuration of the system. For example, although one signage 20 is illustrated in FIG. 2, a plurality of signages 20 may be installed. For example, in the example of FIG. 2, the signage 20 may be installed near each of four desks.

Next, details of each of the devices included in the information notification system according to the first example embodiment will be described.

### Server Device

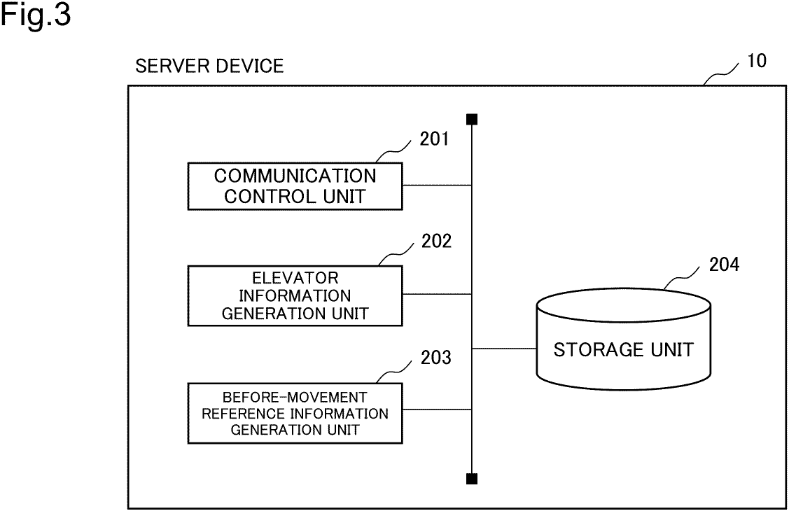

FIG. 3 is a diagram illustrating an example of a processing configuration (processing modules) of the server device 10 according to the first example embodiment. Referring to FIG. 3, the server device 10 includes a communication control unit 201, an elevator information generation unit 202, a before-movement reference information generation unit 203, and a storage unit 204.

The communication control unit 201 is a means for controlling communication with another device. For example, the communication control unit 201 receives data (packet) from the signage 20. Also, the communication control unit 201 transmits data to the signage 20. The communication control unit 201 delivers data received from another device to another processing module. The communication control unit 201 transmits data acquired from another processing module to another device. In this way, another processing module transmits and receives data to and from another device via the communication control unit 201.

The elevator information generation unit 202 is a means (first generation means or first generation unit) for generating elevator information pertaining to a usage status of the elevator. For example, the elevator information generation unit 202 generates elevator information by analyzing image data acquired from the camera device 30.

When the elevator information generation unit 202 analyzes the image data, it is necessary to extract a face image from the image data. A conventional technique can be used for the face image extraction processing, and thus, the detailed description thereof will be omitted. For example, the elevator information generation unit 202 may extract a face image (face area) from the image data using a learning model trained by a convolutional neural network (CNN). Alternatively, the elevator information generation unit 202 may extract a face image using a template matching method or the like.

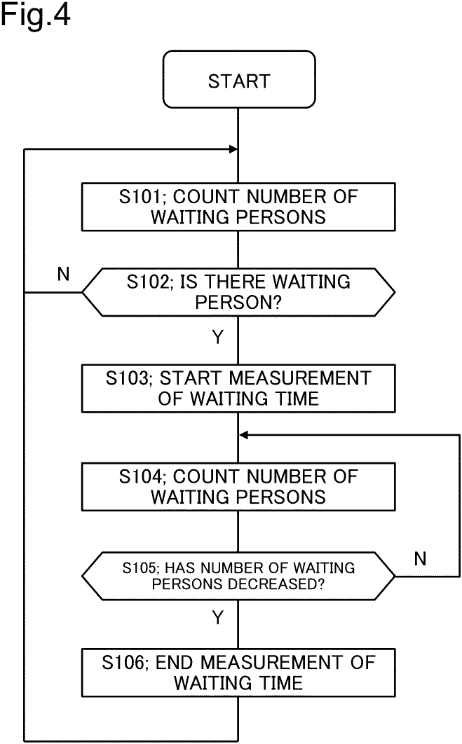

The elevator information generation unit 202 calculates a waiting time for the elevator and the number of users waiting for the elevator to arrive in the elevator hall in accordance with the flowchart illustrated in FIG. 4. The waiting time for the elevator is a time taken until an elevator user gets into the elevator since pressing a button to call the elevator.

The elevator information generation unit 202 counts the number of users (persons waiting for the elevator, hereinafter also referred to simply as “waiting persons”) in the elevator hall (step S101). Specifically, the elevator information generation unit 202 counts the number of persons waiting for the elevator by counting the number of face images extracted from the image data.

The elevator information generation unit 202 determines whether there is a waiting person (step S102).

When there is no waiting person (No in the step S102), the elevator information generation unit 202 repeats the processing of the step S101.

When there is a waiting person (Yes in the step S102), the elevator information generation unit 202 starts measuring a waiting time for the elevator (hereinafter also referred to simply as “waiting time”) (step S103). Specifically, the elevator information generation unit 202 starts a timer for measuring a waiting time. This is because the fact that the waiting person has appeared in the elevator hall can be determined as indicating that the waiting person has called the elevator.

The elevator information generation unit 202 continues to count the number of persons waiting for the elevator (step S104).

The elevator information generation unit 202 determines whether the number of persons waiting for the elevator has decreased since the measurement of the waiting time is started (step S105).

When the number of waiting persons has not decreased (No in the step S105), the elevator information generation unit 202 repeats the processing of the step S104.

When the number of waiting persons has decreased (Yes in the step S105), the elevator information generation unit 202 ends the measurement of the waiting time for the elevator (step S106). This is because the fact that the number of persons waiting for the elevator has decreased can be determined as indicating that the elevator has arrived and the user has got into the elevator.

Thereafter, the elevator information generation unit 202 returns to the step S101 and continues the process. That is, when there is a waiting person even if the number of persons waiting for the elevator has decreased (Yes in the step S102), the elevator information generation unit 202 starts measuring a new waiting time (step S103). On the other hand, when the number of persons waiting for the elevator becomes “0” (No in the step S102), the elevator information generation unit 202 does not measure a waiting time until the user moves to the elevator hall.

As described above, the elevator information generation unit 202 starts measuring a waiting time when a user appears in the elevator hall, and ends the measurement of the waiting time when the number of users existing in the elevator hall decreases. A period from the start to the end of the measurement of the waiting time corresponds to a “waiting time”.

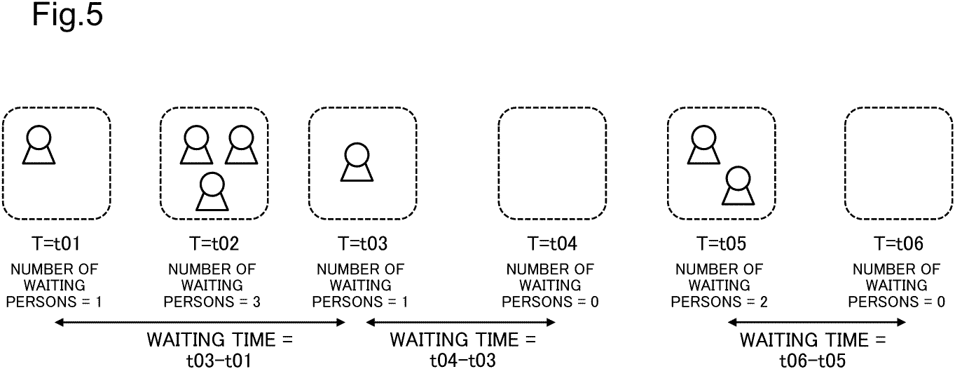

The operation of the elevator information generation unit 202 will be specifically described with reference to FIG. 5. Note that an area surrounded by a dotted line in FIG. 5 indicates an elevator hall.

At time t01, one user enters the elevator hall. Upon detecting the user, the elevator information generation unit 202 starts measuring a waiting time for an elevator.

Thereafter, at time t02, the number of waiting persons becomes “3”. When the time further elapses, the elevator arrives, and the number of waiting persons becomes “1” at time t03. Since the number of waiting persons has decreased at the time t03, the elevator information generation unit 202 ends the measurement of the waiting time. In this case, the waiting time for the elevator is determined as “t03-t01”.

Since there is a waiting person at the time t03, the elevator information generation unit 202 starts measuring a new waiting time. This is because it is considered that the user remaining in the elevator hall has pressed an elevator call button at the time t03.

Thereafter, the number of waiting persons becomes “0” at time t04. Since the number of waiting persons has decreased at the time t04 as well, the elevator information generation unit 202 ends the measurement of the waiting time. In this case, the waiting time for the elevator is determined as “t04-t03”.

Similarly, when detecting that a user exists in the elevator hall (at time t05), the elevator information generation unit 202 starts measuring a waiting time, and ends the measurement at a timing when the number of waiting persons decreases (at time t06).

The elevator information generation unit 202 delivers elevator information (information including a waiting time and the number of waiting persons) to the before-movement reference information generation unit 203 periodically or at a predetermined timing. The elevator information generation unit 202 delivers the information to the before-movement reference information generation unit 203, for example, at a timing when the number of persons waiting for the elevator changes or at a timing when a waiting time is determined (a timing when the measurement of the waiting time ends).

In the example of FIG. 5, the before-movement reference information generation unit 203 is notified of the waiting time for the elevator at each of the times t03, t04, and t06 when the waiting time is determined. Alternatively, the before-movement reference information generation unit 203 may be notified of the number of waiting persons at each of the times t01 to t06 when the number of waiting persons changes.

The before-movement reference information generation unit 203 is a means (second generation means or second generation unit) for generating before-movement reference information to be referred to by a user for movement using the elevator based on at least the elevator information. For example, the before-movement reference information generation unit 203 may generate before-movement reference information including the elevator information as it is.

The before-movement reference information generation unit 203 delivers the generated before-movement reference information to the communication control unit 201. The communication control unit 201 outputs the before-movement reference information to the signage 20. That is, the communication control unit 201 has a function as an “output unit”.

The before-movement reference information generation unit 203 may perform statistical processing on the acquired elevator information (a waiting time or the number of waiting persons) and generate before-movement reference information on the basis of a statistical processing result. For example, the before-movement reference information generation unit 203 may calculate an average value of waiting times or the numbers of waiting persons using time-series data obtained by accumulating the acquired elevator information. At that time, the before-movement reference information generation unit 203 may calculate an average value of waiting times or the numbers of waiting persons during a period from a predetermined time before information is generated to the information-generated time (e.g., 10 minutes).

The before-movement reference information generation unit 203 may calculate a mode value or a median value of waiting times or the numbers of waiting persons. The before-movement reference information generation unit 203 may give a weight that places importance on the latest waiting time or the latest number of waiting persons to time-series data, and calculate a weighted average of waiting times and the numbers of waiting persons.

The before-movement reference information generation unit 203 may generate before-movement reference information including a maximum value or a minimum value of waiting times and the numbers of waiting persons during a predetermined period.

The before-movement reference information generation unit 203 may calculate an index (a variance or a standard deviation) indicating a “variation” in the waiting time or the number of waiting persons, and use an average value of waiting times or the numbers of waiting persons as the before-movement reference information when the variation is smaller than a predetermined value. This is because the average value (the average value of waiting times or the average value of the numbers of waiting persons) is less reliable when the variation is great.

The storage unit 204 is a means for storing information required for operating the server device 10.

### Signage

The signage 20 is a digital bulletin board that displays external reference information.

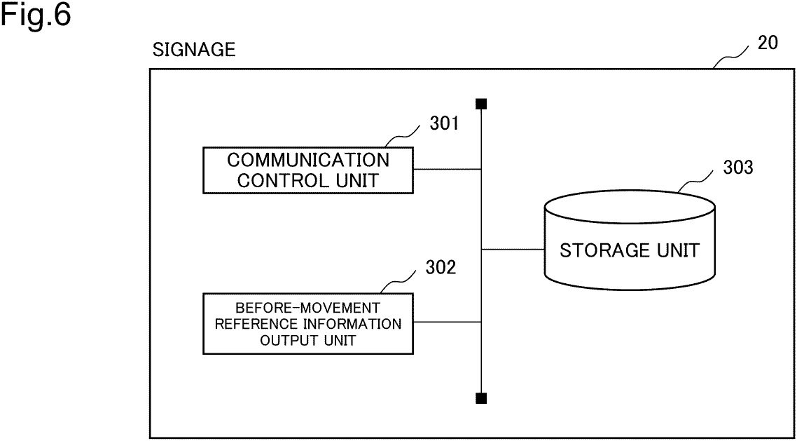

FIG. 6 is a diagram illustrating an example of a processing configuration (processing modules) of the signage 20 according to the first example embodiment. Referring to FIG. 6, the signage 20 includes a communication control unit 301, a before-movement reference information output unit 302, and a storage unit 303.

The communication control unit 301 is a means for controlling communication with another device. For example, the communication control unit 301 receives data (packet) from the server device 10. Also, the communication control unit 301 transmits data to the server device 10. The communication control unit 301 delivers data received from another device to another processing module. The communication control unit 301 transmits data acquired from another processing module to another device. In this way, another processing module transmits and receives data to and from another device via the communication control unit 301.

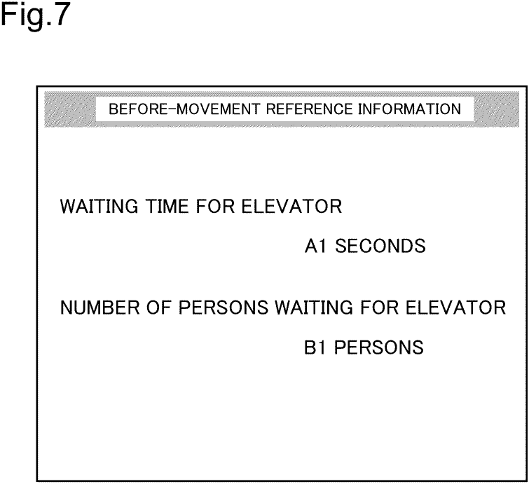

The before-movement reference information output unit 302 is a means for outputting the before-movement reference information acquired from the server device 10. For example, the before-movement reference information output unit 302 outputs (updates) a display as illustrated in FIG. 7 at a timing when the information is acquired from the server device 10.

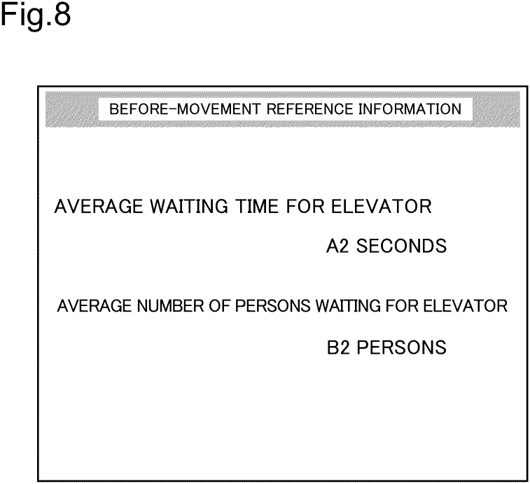

When before-movement reference information pertaining to average values of waiting times and the numbers of waiting persons is acquired from the server device 10, the before-movement reference information output unit 302 may output a display as illustrated in FIG. 8.

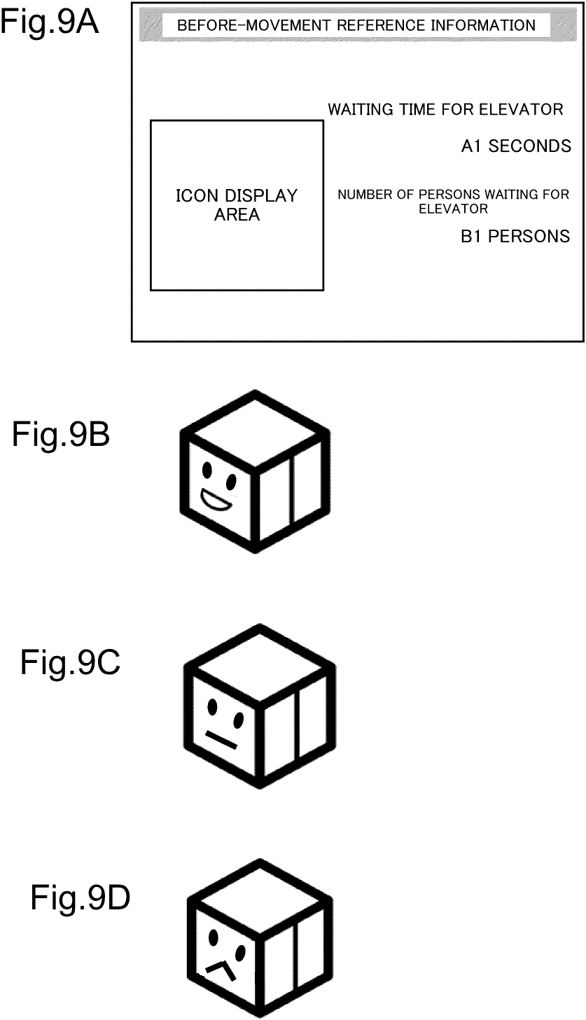

Alternatively, the before-movement reference information output unit 302 may generate and display an “icon” that briefly indicates a usage status of the elevator. For example, as illustrated in FIG. 9(a), the before-movement reference information output unit 302 may provide an “icon display area” and display an icon in the display area.

Various forms may be considered in generating an icon indicating a usage status of the elevator. For example, the before-movement reference information output unit 302 may execute threshold processing on the waiting time for the elevator and/or the number of persons waiting for the elevator, and generate an icon on the basis of a threshold processing result.

For example, when the waiting time or the number of waiting persons is smaller than a threshold value TH1, the before-movement reference information output unit 302 determines that the elevator (elevator hall) is sparse and generates an icon as illustrated in FIG. 9(b). When the waiting time or the number of waiting persons is larger than a threshold value TH2, the before-movement reference information output unit 302 determines that the elevator is congested and generates an icon as illustrated in FIG. 9(d). When the waiting time or the number of waiting persons is equal to or larger than the threshold value TH1 and equal to or smaller than the threshold value TH2, the before-movement reference information output unit 302 determines that a congested degree of the elevator is medium (normal) and generates an icon as illustrated in FIG. 9(c).

In this way, the before-movement reference information output unit 302 may sort the usage status of the elevator (a waiting time and the number of waiting persons) as one of a plurality of stages, and generate an icon related to each of the plurality of stages. That is, the before-movement reference information output unit 302 may generate an icon related to a congested degree (small, medium, or large), with the waiting time and the number of waiting persons being treated as indices indicating the congested degree of the elevator.

The before-movement reference information output unit 302 may display a moving image (animation) for indicating a status (sparse, normal, or congested) of the elevator in the icon display area instead of a still image as an icon. That is, the before-movement reference information output unit 302 may sort the usage status of the elevator as one of a plurality of stages, and generate an animation related to each of the plurality of stages. The before-movement reference information output unit 302 may reproduce the generated animation in the icon display area illustrated in FIGS. 9.

The before-movement reference information output unit 302 may change a color or the like in all or some of the display area of the signage 20 according to the usage status of the elevator. For example, when the elevator is empty, the before-movement reference information output unit 302 sets all of the display area to blue. When the elevator is crowded, the before-movement reference information output unit 302 sets all of the display area to red. The before-movement reference information output unit 302 may change the color of the icon described above according to the usage status of the elevator.

The before-movement reference information output unit 302 may independently control a design of an icon (a pattern; an expression when the elevator is anthropomorphized as illustrated in FIGS. 9) and a color of an icon. For example, the before-movement reference information output unit 302 may control the waiting time to be related to the design of the icon, and control the number of waiting persons to be related to the color of the icon. For example, the before-movement reference information output unit 302 changes an expression of an icon to be related to a congested degree (sparse, normal, or congested), with a waiting time being treated as the congested degree. Further, the before-movement reference information output unit 302 changes a color of an icon based on the number of waiting persons. For example, the before-movement reference information output unit 302 colors the icon red when the number of waiting persons is large, blue when the number of waiting persons is middle, and gray when the number of waiting persons is small.

Alternatively, the before-movement reference information output unit 302 may control the number of waiting persons to be related to the design of the icon, and control the waiting time to be related to the color of the icon. Further, the before-movement reference information output unit 302 changes an expression of an icon based on the number of waiting persons. Further, the before-movement reference information output unit 302 may change a color of an icon based on the waiting time. For example, the before-movement reference information output unit 302 colors the icon red when the waiting time is long, blue when the waiting time is middle, and gray when the waiting time is short.

In this way, the before-movement reference information output unit 302 may control (change) the pattern and color of the icon using different parameters. By taking such a countermeasure, a user (a user who is considering moving from the floor) can easily check a status (a waiting time and the number of waiting persons) of the elevator by checking a pattern (expression) and a color of an icon displayed on the signage 20. That is, the before-movement reference information output unit 302 improves the convenience of the user by visualizing the status of the elevator.

The before-movement reference information output unit 302 may calculate a usage status of the elevator, taking into account two pieces of information, i.e., a waiting time and the number of waiting persons, all together. For example, the before-movement reference information output unit 302 may arrange a function for outputting a usage status (sparse, normal, or congested) of the elevator using a waiting time and the number of waiting persons as input parameters. The function may be arranged to output the usage status by performing threshold processing on a result of calculation such as addition or multiplication of the waiting time and the number of waiting persons.

The usage status of the elevator may be calculated based on a learning model generated by machine learning. Specifically, an administrator or the like generates the learning model (classification model) by performing machine learning using teacher data in which a label (usage status; sparse, normal, or congested) is given to a combination of a waiting time and the number of waiting persons. The before-movement reference information output unit 302 inputs the waiting time and the number of waiting persons to the generated learning model to acquire a usage status. Note that any algorithm such as a support vector machine, boosting, or a neural network can be used to generate a learning model. Note that a known technique can be used for the algorithm such as a support vector machine, and thus, the description thereof will be omitted.

The storage unit 303 is a means for storing information required for operating the signage 20.

As described above, the server device 10 according to the first example embodiment outputs before-movement reference information including a usage status of the elevator to the signage 20. An employee or the like working in an office or the like can determine whether to move to the elevator hall (a place for taking the elevator) by checking the information (a waiting time and the number of waiting persons) pertaining to the elevator displayed on the signage 20. Therefore, the employee or the like can flexibly determine whether to move using the elevator.

### Second Example Embodiment

Next, a second example embodiment will be described in detail with reference to the drawings.

In the first example embodiment, it has been described that elevator information is generated using image data obtained from the camera device 30 overlooking the elevator hall. The second example embodiment will be described for a case where a person pressing a button is identified using biometric information and a waiting time in an elevator hall is calculated.

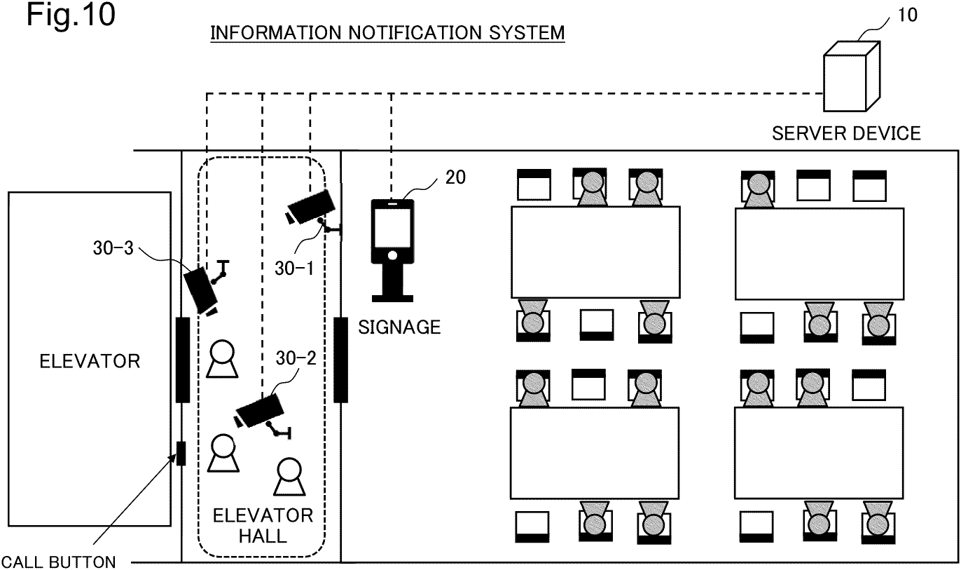

FIG. 10 is a diagram illustrating an example of a schematic configuration of an information notification system according to the second example embodiment. As illustrated in FIG. 10, the system includes three camera devices 30-1 to 30-3 connected to the server device 10.

Note that the processing configurations of the server device 10 and the signage 20 according to the second example embodiment can be the same as those according to the first example embodiment, and thus, the description thereof corresponding to FIGS. 3 and 6 will be omitted.

Hereinafter, the description will be made, focusing on differences between the first and second example embodiments.

Similarly to the camera device in the first example embodiment, the camera device 30-1 is installed to be able to image the entire elevator hall. The camera device 30-2 is installed to be able to simultaneously acquire an image of a call button for calling the elevator and a face image of a user who presses the call button. The camera device 30-3 is installed to be able to acquire a face image of a user getting into the elevator. More specifically, a mirror is installed on a surface where the call button is installed, and the camera device 30-3 is installed in such a manner as to image the call button from behind the person pressing the button. Image data obtained from the camera device 30-3 includes both an image of the call button and an image of a face of the person pressing the button who is reflected in the mirror.

The server device 10 generates elevator information (a waiting time and the number of waiting persons) by analyzing the image data obtained from the three camera devices 30-1 to 30-3.

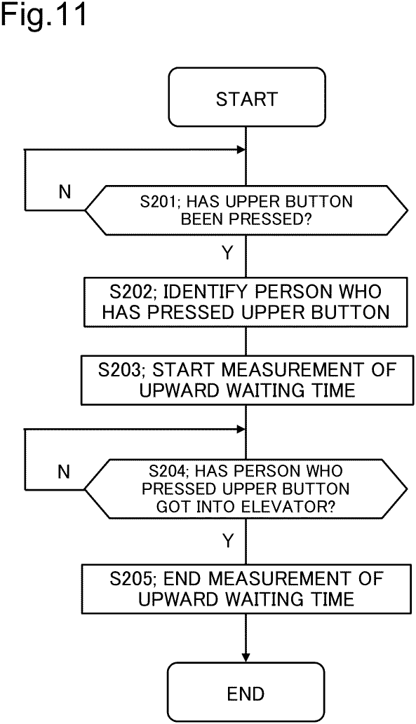

FIG. 11 is a flowchart illustrating an example of an operation of the elevator information generation unit 202 according to the second example embodiment. Note that FIG. 11 illustrates an example of an operation in a case where an upper one of the two elevator call buttons is pressed.

The elevator information generation unit 202 determines whether the upper button has been pressed by analyzing image data obtained from the camera device 30-2 (step S201). For example, the elevator information generation unit 202 calculates a difference between an image in which the upper button is not pressed and an image obtained from the camera device 30-2, and determines that the upper button has been pressed when there is a change in upper button area (when there is a change in color or the like of the button).

When the upper button has not been pressed (No in the step S201), the elevator information generation unit 202 repeats the processing of the step S201.

When the upper button has been pressed (Yes in the step S201), the elevator information generation unit 202 identifies a person who has pressed the upper button (step S202). Specifically, the elevator information generation unit 202 extracts a face image of the user appearing in the image in which the upper button is pressed, and generates a feature amount from the face image.

The elevator information generation unit 202 generates, from the extracted face image, a feature amount (a feature vector including a plurality of feature amounts) that characterizes the face image. Specifically, the elevator information generation unit 202 extracts feature points from the face image. Concerning a process of extracting feature points, a conventional technique can be used, and thus, the detailed description thereof will be omitted. For example, the elevator information generation unit 202 extracts an eye, a nose, a mouth, and the like as feature points from the face image. Thereafter, the elevator information generation unit 202 calculates a position of each of the feature points and a distance between the feature points as feature amounts, and generates a feature vector (vector information characterizing the face image) including the plurality of feature amounts.

Thereafter, the elevator information generation unit 202 starts measuring a waiting time for the elevator heading for an upper floor (hereinafter referred to as an upward waiting time) (step S203). Specifically, the elevator information generation unit 202 starts a timer for measuring an upward waiting time.

The elevator information generation unit 202 determines whether the person who pressed the upper button has got into the elevator by analyzing image data obtained from the camera device 30-3 (step S204). Specifically, the elevator information generation unit 202 attempts to extract face images from the image data obtained from the camera device 30-3. The elevator information generation unit 202 determines whether the face image identified in the step S202 is included the face images extracted from the face image. Specifically, the elevator information generation unit 202 calculates a degree of similarity between the face image included in the image data obtained from the camera device 30-3 and the face image of the person who has pressed the upper button. When the calculated similarity is equal to or larger than a predetermined threshold, the elevator information generation unit 202 determines that the two face images are substantially identical to each other. When the two face images are substantially identical to each other, the elevator information generation unit 202 determines that the person who pressed the upper button has got into the elevator.

For the degree of similarity calculated by the elevator information generation unit 202, a chi-square distance, a Euclidean distance, or the like can be used. The degree of similarity is lower as the distance is longer, and the degree of similarity is higher as the distance is shorter.

When the person who pressed the upper button has not got into the elevator (No in the step S204), the elevator information generation unit 202 repeats the processing of the step S204.

When the person who pressed the upper button has got into the elevator (Yes in the step S204), the elevator information generation unit 202 ends the measurement of the upward waiting time (step S205). Specifically, the elevator information generation unit 202 stops the timer for measuring the upward waiting time.

In this way, when the call button for calling the elevator is pressed, the elevator information generation unit 202 identifies a person who has pressed the call button and starts measuring a waiting time. As a result of analyzing the image data, when it is determined that the person who pressed the call button has got into the elevator that has arrived at the elevator hall, the elevator information generation unit 202 ends the measurement of the waiting time.

Similarly, the elevator information generation unit 202 can calculate a waiting time for the elevator heading for a lower floor (a downward waiting time). The “upper button” and the “upward waiting time” described with reference to FIG. 11 may be replaced with the “lower button” and the “downward waiting time”, respectively, and thus, the detailed description regarding the calculation of the downward waiting time will be omitted.

The number of persons waiting for the elevator can be calculated in a similar manner to that in the first example embodiment, and thus, the detailed description thereof will be omitted. The elevator information generation unit 202 may count the number of users existing in the elevator hall by analyzing image data obtained from the camera device 30-1.

The elevator information generation unit 202 may deliver the upward waiting time and the downward waiting time to the before-movement reference information generation unit 203 as “the waiting time for the elevator” in a state where these times are not distinguished from each other, or may deliver the upward waiting time and the downward waiting time to the before-movement reference information generation unit 203 in a state where these times are distinguished from each other.

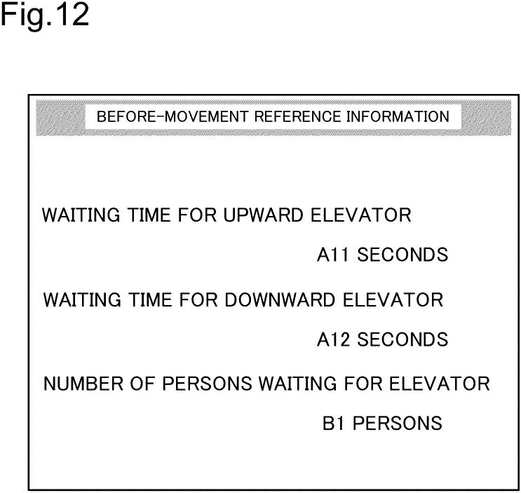

When the upward waiting time and the downward waiting time are separately provided to the signage 20 via the before-movement reference information generation unit 203, the signage 20 may separately display the waiting time for the elevator heading for the upper floor and the waiting time for the elevator heading for the lower floor (see FIG. 12).

As described above, the server device 10 according to the second example embodiment can also present before-movement reference information to an employee or the like, similarly to that according to the first example embodiment. Therefore, the employee or the like can flexibly determine whether to move using the elevator.

### Third Example Embodiment

Next, a third example embodiment will be described in detail with reference to the drawings.

The third example embodiment will be described for a case where going-out reference information is generated by adding information other than the elevator information.

Note that the configuration of the information notification system according to the third example embodiment can be the same as that according to the first example embodiment, and thus, the description thereof corresponding to FIG. 2 will be omitted. In addition, the processing configuration of the signage 20 according to the third example embodiment can also be the same as that according to the first example embodiment, and thus, the description thereof will be omitted.

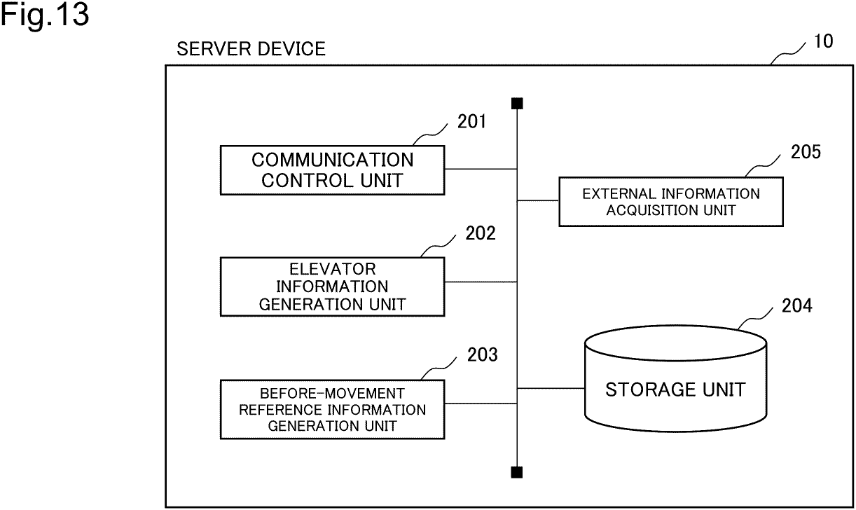

FIG. 13 is a diagram illustrating an example of a processing configuration (processing modules) of a server device 10 according to the third example embodiment. Referring to FIG. 13, an external information acquisition unit 205 is added to the server device 10 according to the first example embodiment.

Hereinafter, the description will be made, focusing on differences between the first to third example embodiments.

The external information acquisition unit 205 is a means for mainly acquiring external information by accessing an external server or the like. Note that the presence of the external server serving as a source of external information to be exemplified below is obvious to those of ordinary skill in the art, and thus, the detailed description thereof will be omitted. For example, the external information acquisition unit 205 may access a server that provides meteorological information or weather information on a network.

For example, the external information acquisition unit 205 acquires time information pertaining to a date and time, a day of the week, and the like from the external server or the like.

Alternatively, the external information acquisition unit 205 acquires meteorological information pertaining to a temperature, a humidity, and the like in an area including an office from the external server or the like.

Alternatively, the external information acquisition unit 205 acquires weather information pertaining to weather (sunny, raining, cloudy, etc.) or the like in an area including an office from the external server or the like.

Alternatively, the external information acquisition unit 205 acquires disaster information pertaining to a disaster (earthquake, tsunami, heavy rain, etc.) or the like in an area including an office from the external server or the like.

Alternatively, the external information acquisition unit 205 acquires traffic information pertaining to an accident or the like that has occurred in a route or the like closest to an office from the external server or the like.

Alternatively, the external information acquisition unit 205 acquires congestion information pertaining to congestion in a dining hall, a toilet, a rest room, or the like from the external server, another server, or the like. Alternatively, a camera device may be installed at an entrance or an exit of the foregoing facility, and the external information acquisition unit 205 may count the number of persons using the dining hall or the like to obtain congestion information by analyzing an image obtained from the camera device.

The external information acquisition unit 205 delivers the acquired external information (meteorological information, weather information, disaster information, traffic information, etc.) to the before-movement reference information generation unit 203.

The before-movement reference information generation unit 203 generates before-movement reference information using at least one of the elevator information and the external information, and provides the generated before-movement reference information to the signage 20.

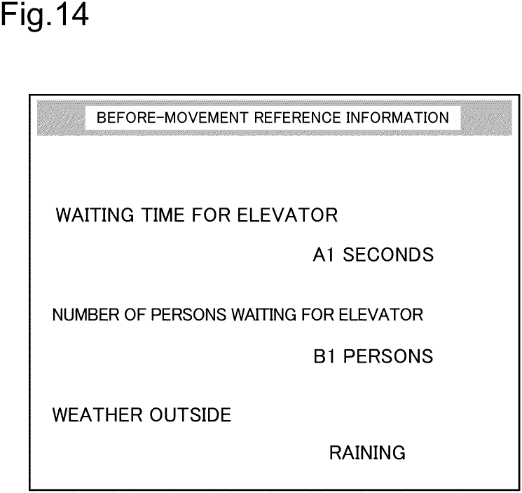

The signage 20 displays the acquired before-movement reference information. For example, the signage 20 that has acquired the before-movement reference information including the elevator information and the weather information performs a display as illustrated in FIG. 14. When displaying an element of the external information, the signage may notify an employee or the like of the content of the external information, using an icon instead of characters. In the example of FIG. 14, an icon “umbrella” may be displayed instead of a word “raining”.

As described above, the server device 10 according to the third example embodiment outputs not only elevator information but also external information such as time information, climate information, and weather information to the signage 20. An employee or the like can determine whether it is necessary to move or the like, taking into account the information (climate information, weather information, etc.) displayed on the signage 20 all together. For example, a user can stop moving or move with an outerwear according to a temperature. Alternatively, a user can also determine to go out with an umbrella when it is raining.

### Fourth Example Embodiment

Next, a fourth example embodiment will be described in detail with reference to the drawings.

The fourth example embodiment will be described for a case where an elevator is controlled based on a user’s schedule.

Note that the configuration of the information notification system according to the fourth example embodiment can be the same as that according to the first example embodiment, and thus, the description thereof corresponding to FIG. 2 will be omitted. However, in the fourth example embodiment, a camera device is installed to be able to image a user (particularly, a face of the user) heading toward an elevator hall from an office (floor). For example, the camera device is installed at a passage or the like. In addition, the processing configuration of the signage 20 according to the fourth example embodiment can also be the same as that according to the first example embodiment, and thus, the description thereof will be omitted.

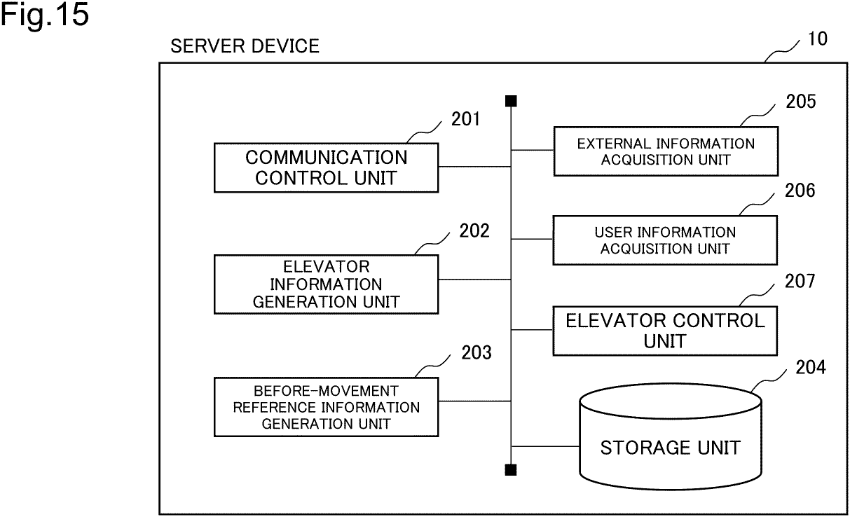

FIG. 15 is a diagram illustrating an example of a processing configuration (processing modules) of a server device 10 according to the third example embodiment. Referring to FIG. 15, an external information acquisition unit 205, a user information acquisition unit 206, and an elevator control unit 207 are added to the server device 10 according to the first example embodiment.

Hereinafter, the description will be made, focusing on differences between the first to fourth example embodiments.

The user information acquisition unit 206 acquires biometric information (e.g., a face image) and schedule information (e.g., a schedule pertaining to a meeting or an outing) for a user using a certain means.

For example, the user information acquisition unit 206 acquires a face image of the user from a terminal (a terminal such as a smartphone) possessed by the user. The user operates the terminal to image his/her face, and transmits image data to the server device 10. Alternatively, the user information acquisition unit 206 may acquire the biometric information by displaying a graphical user interface (GUI) or a fill-in form for acquiring a face image on the terminal of the user. At this time, the user information acquisition unit 206 also acquires identification information (a user ID, e.g., an employee number) for the user, and stores the identification information in association with the face image.

The user information acquisition unit 206 acquires information pertaining to a schedule of the user (schedule information). For example, by transmitting a user ID to a database that stores schedule information for users, the user information acquisition unit 206 may acquire schedule information related to the user ID. Alternatively, the user may directly input schedule information to the server device 10 by operating a terminal possessed by the user. The user information acquisition unit 206 may provide a GUI or the like for the user to input schedule information.

The user information acquisition unit 206 registers the biometric information and the schedule information acquired by the certain means in the schedule information database.

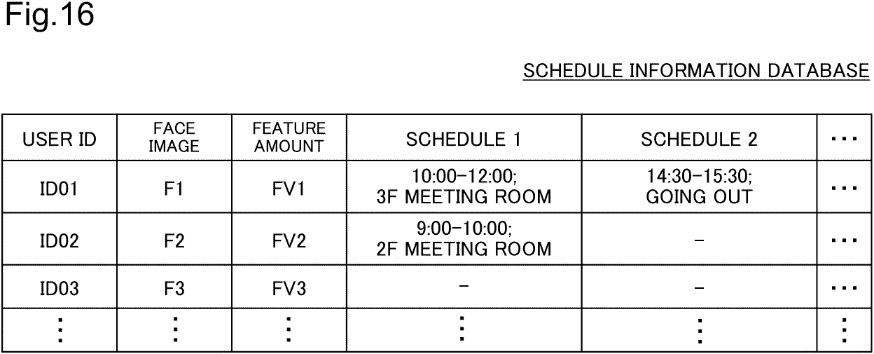

FIG. 16 is a diagram illustrating an example of a schedule information database. As illustrated in FIG. 16, the schedule information database stores a user ID, biometric information (e.g., a face image and a feature amount), and schedule information for a user in association with each other. The schedule information includes information such as a time during which the user leaves an office or a floor (a schedule start time and a schedule end time) and a destination.

The elevator control unit 207 controls the elevator, particularly concerning calling the elevator, based on the schedule information for the user. The elevator control unit 207 acquires image data from a camera device installed at a passage or the like. The elevator control unit 207 extracts a face image from the image data. The elevator control unit 207 generates a feature amount (a feature vector including a plurality of feature amounts) from the face image.

The elevator control unit 207 executes one-to-N collation (N is a positive integer, and the same applies hereinafter) using the generated feature amount and feature amounts registered in the schedule information database. By performing the one-to-N collation, the elevator control unit 207 identifies an entry having a feature amount substantially matching the biometric information for the user appearing in the image data.

A face image extraction process, a feature amount generation process, and a one-to-N collation process can be performed by the elevator control unit 207 using conventional techniques, and are obvious to those of ordinary skill in the art, and thus, the detailed description thereof will be omitted.

When a value is set in a schedule field of the identified entry, the elevator control unit 207 determines that the user moves using the elevator. The elevator control unit 207 controls the elevator (calls the elevator) to be suitable for the expected movement of the user.

In a case where it is expected that the user moves to an upper floor, the elevator control unit 207 controls the elevator to be equivalent to a case where the upper button is pressed. In a case where it is expected that the user moves to a lower floor, the elevator control unit 207 controls the elevator to be equivalent to a case where the lower button is pressed.

The detailed description about the control of the elevator by the elevator control unit 207 will be omitted. The control of the elevator is achieved by installing an application programming interface (API) for inputting pressing of a call button (upper button or lower button) in a conventional elevator control system.

The elevator control unit 207 may control the elevator using the time information of the schedule information. For example, the elevator control unit 207 may compare a current time with a schedule start time, and perform an elevator call control in a case where the current time is a predetermined time before the start time (e.g., 5 minutes before the start time) or in a case where the current time has passed the start time.

The server device 10 may link the control of the elevator and the control of the signage 20 to each other. For example, when the elevator control unit 207 performs an elevator call control, floor sojourners may be informed through the signage 20 that the elevator has been called. In this case, the before-movement reference information generation unit 203 transmits, to the signage 20, information enabling the signage 20 to display “the elevator has been called”. In this case, the signage 20 displays a call button (upper button or lower button) as if it is shining. In this way, the elevator control unit 207 may identify an elevator user based on face authentication and schedule information for the user, and the signage 20 may perform a display for informing that the elevator has been called (e.g., displaying a shining call button). Alternatively, the name or the like of the person who triggered the elevator call (the user identified through the face authentication) may be displayed on the signage 20.

When a plurality of users are extracted from image data and each of the users has a schedule, the elevator control unit 207 may determine a destination of an elevator to be called depending on times remaining until the respective schedules of the users are started. For example, when a user A and a user B are included in image data and a meeting of the user A is scheduled to be started earlier than a meeting of the user B, the elevator control unit 207 controls the elevator to prioritize the movement of the user A having no time to spare.

The elevator control unit 207 may use not only the image data obtained from the camera device installed at the passage but also image data obtained from another camera device. For example, a camera device is installed at the signage 20. The elevator control unit 207 authenticates (identifies) a user from the camera device of the signage 20, and checks a schedule of the user. When it is determined that the elevator is to be used as a result of checking the schedule of the user, the elevator control unit 207 calls the elevator. For a user who is not scheduled to use the elevator or a user who has time until a schedule start time, the before-movement reference information generation unit 203 may display content (e.g., news or the like) on the signage 20 in order to keep the user.

As described above, the server device 10 according to the fourth example embodiment identifies a user heading for the elevator hall from image data in which the user heading for the elevator hall appears. The server device 10 controls the calling of the elevator based on schedule information for the identified user. That is, the server device 10 identifies a user heading for the elevator hall using biometric authentication (face authentication). When it is determined that the user moves using the elevator referring to the schedule information for the identified user, the server device 10 calls the elevator. As a result, it is possible to reduce a time during which the user is waiting in the elevator hall, thereby expecting an improvement in production efficiency for a company or the like.

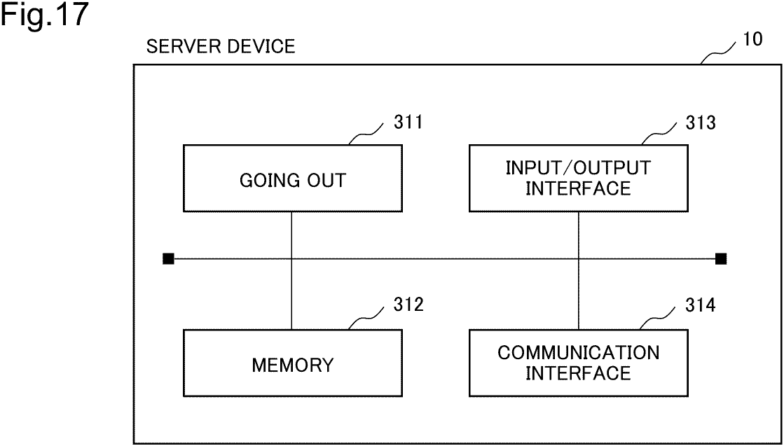

Next, hardware of each of the devices constituting the information notification system will be described. FIG. 17 is a diagram illustrating an example of a hardware configuration of the server device 10.

The server device 10 has a configuration illustrated in FIG. 17. For example, the server device 10 includes a processor 311, a memory 312, an input/output interface 313, a communication interface 314, etc. The components such as the processor 311 are connected to each other by an internal bus or the like, and are configured to be able to communicate with each other.

However, the configuration illustrated in FIG. 17 is not intended to limit the hardware configuration of the server device 10. The server device 10 may include hardware that is not illustrated, or may not include the input/output interface 313 if necessary. In addition, the number of processors 311 and the like included in the server device 10 is not limited to the example of FIG. 17, and for example, a plurality of processors 311 may be included in the server device 10.

The processor 311 is a programmable device, e.g., a central processing unit (CPU), a micro processing unit (MPU), or a digital signal processor (DSP). Alternatively, the processor 311 may be a device such as a field programmable gate array (FPGA) or an application specific integrated circuit (ASIC). The processor 311 executes various programs including an operating system (OS).

The memory 312 is a random access memory (RAM), a read only memory (ROM), a hard disk drive (HDD), a solid state drive (SSD), or the like. The memory 312 stores an OS program, an application program, and various kinds of data.

The input/output interface 313 is an interface of a display device or an input device that is not illustrated. The display device is, for example, a liquid crystal display or the like. The input device is, for example, a device that receives a user’s operation such as a keyboard or a mouse.

The communication interface 314 is a circuit, a module, or the like that communicates with another device. For example, the communication interface 314 includes a network interface card (NIC) or the like.

The functions of the server device 10 are achieved by various processing modules. The processing modules are implemented, for example, by the processor 311 executing the programs stored in the memory 312. Furthermore, the program can be recorded in a computer-readable storage medium. The storage medium may be a non-transient (non-transitory) medium such as a semiconductor memory, a hard disk, a magnetic recording medium, or an optical recording medium. That is, the present invention can also be embodied as a computer program product. Furthermore, the program can be downloaded via a network or updated using a storage medium storing the program. Furthermore, the processing module may be implemented by a semiconductor chip.

Also, the signage 20 can be configured similarly to the server device 10, and is not different in basic hardware configuration from the server device 10, and thus, the description thereof will be omitted.

The server device 10 has a computer mounted thereon, and the functions of the server device 10 can be achieved by causing the computer to execute the program. In addition, the server device 10 executes a control method through the program.

### Modifications

Note that the configuration, operation, and the like of the information notification system described in the above example embodiments are merely exemplary, and are not intended to limit the configuration and the like of the system.

For example, the server device 10 and the signage 20 may be integrated, and one integrated device may notify an employee or the like in an office of before-movement reference information.

Although the above example embodiments have been described on the assumption that one elevator is operated, but elevator information may be generated similarly even in a case where two or more elevators are operated. For example, in a case where a plurality of elevators arrive at one elevator hall, the server device 10 may execute calculation processing for both a waiting time for an upward elevator and a waiting time for a downward elevator, which have been described in the second example embodiment.

In a case where a plurality of elevators are operated, the server device 10 may generate elevator information and before-movement reference information for each elevator.

The signage 20 may change the detail of the before-movement reference information to be displayed according to a time zone. For example, in a time zone during which it is expected that the use of the elevator increases, such as a lunch time or a time to go home, the signage 20 mainly displays elevator information. On the other hand, in a time zone during which it is expected that the elevator is not crowded, the signage 20 mainly displays traffic information, weather information, or the like.

Although the above example embodiments have been described for a case where the server device 10 transmits before-movement reference information to the signage 20, the server device 10 may transmit before-movement reference information to a terminal used by an employee or the like (e.g., a personal computer or a smartphone).

The second example embodiment has been described for a case where a waiting time for the elevator is calculated using a plurality of camera devices. However, in a case where image data necessary for calculation of elevator information can be acquired through one camera device 30, a plurality of camera devices are not necessary.

The above example embodiments have been described for a case where elevator information is generated by analyzing image data obtained from the camera device installed in the elevator hall. The server device 10 may generate elevator information based on information obtained from the elevator control system instead of or in addition to the analysis of the image data. That is, the server device 10 may generate the elevator information in conjunction (linkage or cooperation) with the elevator control system. For example, the server device 10 may use a button pressing notification from the elevator control system, rather than determining whether a user has pressed the call button by analyzing image data. For example, a camera device is installed near the call button (e.g., immediately above the call button). When receiving a notification from the elevator control system that the button has been pressed, the server device 10 instructs the camera device installed near the button to image a user. The server device 10 sets a person appearing in the obtained image data as a person who has pressed the button. In this way, the server device 10 and the elevator control system are linked with each other, thereby making it possible to accurately identify a person who has pressed the button.

The above example embodiments have been described for a case where a person who has pressed the button is identified using the camera device 30-2 and the mirror, but a person who has pressed the button can be identified through one camera device without using the mirror. Specifically, a camera device is installed beside the call button to image a user. The server device 10 executes template matching processing on an image obtained from the camera device to identify a person taking an arm stretching posture to press the call button. The server device 10 may treat a person taking a predetermined posture as a person who has pressed the button.

In the flow charts (flowcharts or sequence diagrams) used in the above description, a plurality of steps (processes) are described in order, but an order in which the steps are executed according to the example embodiments is not limited to the described order. According to the example embodiments, the order of the steps as illustrated can be changed without departing from the gist, for example, executing the processes in parallel.

The above example embodiments have been described in detail to make it easy to understand the disclosure of the present application, and it is not intended that all the configurations described above are necessary. In addition, in a case where a plurality of example embodiments have been described, the example embodiments may be used each alone or in combination. For example, some configurations of one example embodiment can be replaced with configurations of another example embodiment, or configurations of one example embodiment can be added to configurations of another example embodiment. Furthermore, some configurations of each example embodiment can be deleted, or added or replaced to or with other configurations.

Although the industrial applicability of the present invention is apparent from the above description, the present invention can be preferably applied to an information notification system for a company or the like.

Some or all of the above-described example embodiments can be described as in the following supplementary notes, but are not limited to the following supplementary notes.

### Supplementary Note 1

A server device including:
a first generation unit that generates elevator information pertaining to a usage status of an elevator by analyzing image data obtained from one or more camera devices;
a second generation unit that generates before-movement reference information to be referred to by a user for movement, based on at least the generated elevator information; and
an output unit that outputs the generated before-movement reference information to a signage.

### Supplementary Note 2

The server device according to supplementary note 1, in which the first generation unit generates the elevator information including a waiting time for the elevator and the number of persons waiting for the elevator to arrive.

### Supplementary Note 3

The server device according to supplementary note 2, in which the first generation unit starts measuring the waiting time when the user appears in an elevator hall, and ends the measurement of the waiting time when the number of users existing in the elevator hall decreases.

### Supplementary Note 4

The server device according to supplementary note 2, in which when a call button for calling the elevator is pressed, the first generation unit identifies a person who has pressed the call button and starts measuring the waiting time, and

when the person who pressed the call button has got into the elevator that has arrived at the elevator hall, the first generation unit ends the measurement of the waiting time.

### Supplementary Note 5

The server device according to any one of supplementary notes 2 to 4, in which the second generation unit generates the before-movement reference information based on a result of statistical processing performed on the waiting time or the number of waiting persons included in the elevator information.

### Supplementary Note 6

The server device according to supplementary note 5, in which the second generation unit calculates an average value related to the waiting time or the number of waiting persons.

### Supplementary Note 7

The server device according to any one of supplementary notes 1 to 6, further including an external information acquisition unit that acquires external information from an external server,

in which the second generation unit generates the before-movement reference information using at least one of the elevator information and the external information.

### Supplementary Note 8

The server device according to supplementary note 7, in which the external information acquisition unit acquires at least one of meteorological information, weather information, disaster information, and traffic information as the external information.

### Supplementary Note 9

The server device according to supplementary note 1, further including an elevator control unit that identifies the user heading for an elevator hall from image data in which the user heading for the elevator hall appears, and controls calling the elevator based on schedule information for the identified user.

### Supplementary Note 10

A system including:
a signage that displays information acquired from the outside; and
a server device connected to the signage,
in which the server device includes:
   a first generation unit that generates elevator information pertaining to a usage status of an elevator by analyzing image data obtained from one or more camera devices;
   a second generation unit that generates before-movement reference information to be referred to by a user for movement, based on at least the generated elevator information; and
   an output unit that outputs the generated before-movement reference information to the signage.

### Supplementary Note 11

The system according to supplementary note 9, in which the signage generates an icon indicating the usage status of the elevator and displays the generated icon.

### Supplementary Note 12

The system according to supplementary note 10, in which the signage sorts the usage status of the elevator as one of a plurality of stages, and generates an icon corresponding to each of the plurality of stages.

### [Supplementary Note 13]

The system according to supplementary note 9, in which the signage sorts the usage status of the elevator as one of a plurality of stages, generates an animation corresponding to each of the plurality of stages, and reproduces the generated animation.

### Supplementary Note 14

A control method of a server device including:
generating elevator information pertaining to a usage status of an elevator by analyzing image data obtained from one or more camera devices;
generating before-movement reference information to be referred to by a user for movement, based on at least the generated elevator information; and
outputting the generated before-movement reference information to a signage.

### Supplementary Note 15

A computer-readable storage medium storing a program for causing a computer mounted on a server device to execute processing including:
generating elevator information pertaining to a usage status of an elevator by analyzing image data obtained from one or more camera devices;
generating before-movement reference information to be referred to by a user for movement, based on at least the generated elevator information; and
outputting the generated before-movement reference information to a signage.

Note that the disclosure of the cited prior art document is incorporated herein by reference. Although the example embodiments of the present invention have been described above, the present invention is not limited to these example embodiments. It will be understood by those skilled in the art that these example embodiments are merely exemplary and various variations can be made without departing from the scope and spirit of the present invention. That is, it goes without saying that the present invention includes various modifications and alterations that can be made by those skilled in the art in accordance with the entire disclosure including the claims and the technical idea.

Reference signs List

| | |
|---|---|
| 10, 100 | Server device |
| 20 | Signage |
| 30, 30-1 to 30-3 | Camera device |
| 101 | First generation unit |
| 102 | Second generation unit |
| 103 | Output unit |
| 201, 301 | Communication control unit |
| 202 | Elevator information generation unit |
| 203 | Before-movement reference information generation unit |
| 204, 303 | Storage unit |
| 205 | External information acquisition unit |
| 206 | User information acquisition unit |
| 207 | Elevator control unit |
| 302 | Before-movement reference information output unit |
| 311 | Processor |
| 312 | Memory |
| 313 | Input/output interface |
| 314 | Communication interface |

What is claimed is:

1. A server device comprising:
at least one memory storing a computer program; and
at least one processor configured to execute the computer program to generate elevator information pertaining to a usage status of an elevator by analyzing image data obtained from one or more camera devices;
generate before-movement reference information to be referred to by a user for movement, based on at least the generated elevator information; and
output the generated before-movement reference information to a signage.

2. The server device according to claim 1, wherein the processor is configured to execute the computer program to generate the elevator information including a waiting time for the elevator and the number of persons waiting for the elevator to arrive.

3. The server device according to claim 2, wherein the processor is configured to execute the computer program to start measuring the waiting time when the user appears in an elevator hall, and end the measurement of the waiting time when the number of users existing in the elevator hall decreases.

4. The server device according to claim 2, wherein the processor is configured to execute the computer program to,
when a call button for calling the elevator is pressed, identify a person who has pressed the call button and start measuring the waiting time, and
when the person who pressed the call button has got into the elevator that has arrived at the elevator hall, end the measurement of the waiting time.

5. The server device according to claim 2, wherein the processor is configured to execute the computer program to generate the before-movement reference information based on a result of statistical processing performed on the waiting time or the number of waiting persons included in the elevator information.

6. The server device according to claim 5, wherein the processor is configured to execute the computer program to calculate an average value related to the waiting time or the number of waiting persons.

7. The server device according claim 1, wherein the processor is configured to execute the computer program to
acquire external information from an external server, and
generate the before-movement reference information using at least one of the elevator information and the external information.

8. The server device according to claim 7, wherein the processor is configured to execute the computer program to acquire at least one of meteorological information, weather information, disaster information, and traffic information as the external information.

9. The server device according to claim 1, wherein the processor is configured to execute the computer program to
identify the user heading for an elevator hall from image data in which the user heading for the elevator hall appears, and
control calling the elevator based on schedule information for the identified user.

10. A system comprising:
a signage that displays information acquired from the outside; and
a server device connected to the signage,
wherein the server device includes:
at least one memory storing a computer program; and
at least one processor configured to execute the computer program to
generate elevator information pertaining to a usage status of an elevator by analyzing image data obtained from one or more camera devices;
generate before-movement reference information to be referred to by a user for movement, based on at least the generated elevator information; and
output the generated before-movement reference information to the signage.

11. The system according to claim 10, wherein the signage generates an icon indicating the usage status of the elevator and displays the generated icon.

12. The system according to claim 10, wherein the signage sorts the usage status of the elevator as one of a plurality of stages, and generates an icon related to each of the plurality of stages.

13. The system according to claim 10, wherein the signage sorts the usage status of the elevator as one of a plurality of stages, generates an animation related to each of the plurality of stages, and reproduces the generated animation.

14. A control method of a server device comprising:
generating elevator information pertaining to a usage status of an elevator by analyzing image data obtained from one or more camera devices;
generating before-movement reference information to be referred to by a user for movement, based on at least the generated elevator information; and
outputting the generated before-movement reference information to a signage.

15. A non-transitory computer-readable storage medium storing a program for causing a computer mounted on a server device to execute processing comprising:
generating elevator information pertaining to a usage status of an elevator by analyzing image data obtained from one or more camera devices;
generating before-movement reference information to be referred to by a user for movement, based on at least the generated elevator information; and
outputting the generated before-movement reference information to a signage.

16. A control method of a system comprising:
displaying information acquired from the outside on a signage;
in a server device connected to the signage,
generating elevator information pertaining to a usage status of an elevator by analyzing image data obtained from one or more camera devices;
generating before-movement reference information to be referred to by a user for movement, based on at least the generated elevator information; and
outputting the generated before-movement reference information to the signage.
